(19) United States
(12) Patent Application Publication
(10) Pub. No.: US 2004/0260721 A1
(43) Pub. Date: Dec. 23, 2004

(54) Methods and systems for creation of a coherence database

(76) Inventors: Marie Coffin, Cary, NC (US); Matthew Lawrence, Rolesville, NC (US)

Correspondence Address: Icoria, Inc., 108 T.W. ALEXANDER DRIVE, P O BOX 14528, RTP, NC, 27709-4528, US

(21) Appl. No.: 10/871,949

(22) Filed: Jun. 18, 2004

Related U.S. Application Data
(60) Provisional application No. 60/480,038, filed on Jun. 20, 2003.

(51) Int. Cl. G06F 17/30

(52) U.S. Cl. 707/102

(57) ABSTRACT

The present invention provides methods and systems for organizing complex biological data in a database schema that facilitates data analysis in a biological context. Specifically, the methods and systems of the present invention pertain to the creation of an integrated relational database schema for recording and organizing summary data from experiments, relating data from disparate data streams, and relating data to reference information sources. The invention is useful in multiple applications, including applications in the agricultural, pharmaceutical, forensic, biotechnology, and nutriceutical industries.

### RELATED APPLICATION

This application claims the benefit of U.S. Provisional Application No. 60/480,038, filed Jun. 20, 2003, which is incorporated in entirety by reference.

This invention was made with United States Government support under Cooperative Agreement No. 70NANB2H3009 awarded by the National Institute of Standards and Technology (NIST). The United States Government has certain rights in the invention.

### FIELD OF THE INVENTION

The present invention provides methods and systems for organizing complex biological data in a database schema that facilitates data analysis in a biological context. Specifically, the methods of the present invention pertain to the creation of an integrated relational database schema for integrating and analyzing large quantities of heterogeneous data. The invention is useful in multiple applications, including applications in the agricultural, pharmaceutical, forensic, biotechnology, and nutriceutical industries.

### SUMMARY OF THE INVENTION

The present invention provides methods and systems for recording and organizing data summarized from experiments (summary data) and relating data from disparate data streams in an integrated relational database schema that allows relating of empirical data to reference information sources, and facilitates recognition and identification of trends and relationships within complex data. Methods and systems of the present invention are useful in creating a coherence database comprised of at least one data table containing a unique identifier of at least one experiment; at least one data table containing a unique identifier of at least one biological sample; at least one data table containing data measurements from the biological sample; at least one data table containing attribute information; placement of all of the data tables in an integrated relational database schema; and relating the data tables of the integrated relational database schema, through the attribute information, to at least one reference information source. The integrated relational database schema resulting from the methods and systems of the present invention allows data to be examined within a biological context.

### BRIEF DESCRIPTION OF THE FIGURES

FIG. 1 depicts the flow of information in an exemplary coherence database schema.

FIG. 2 depicts the schema of the coherence database (104) of FIG. 1 and is described in detail in the Specific Examples that follow.

### DETAILED DESCRIPTION OF THE INVENTION

Definitions:

Identifying a “baseline” or control value is essential to biological experimentation and provides, but is not limited to, a mechanism for distinguishing perturbed from unperturbed. A baseline is used in the invention to standardize data to a common or commonly relevant unit of measure. The term “baseline” is herein used to refer to and is interchangeable with “reference” and “control.” Baseline populations consist, for example, of data from organisms of a particular group, such as healthy or normal organisms, or organisms diagnosed as having a particular disease state, pathophysiological condition, or other physiological state of interest. An example of the use of a baseline is the expression of data measurements as standard deviations from the corresponding baseline mean.

The term “biochemical pathway” or “pathway” refers to a connected series of biochemical reactions normally occurring in a cell, or more broadly, a cellular event such as cellular division or DNA replication. Typically, the steps in such a biochemical pathway act in a coordinated fashion to produce a specific product or products or to produce some other particular biochemical action. Such a biochemical pathway requires the expression product of a gene if the absence of that expression product either directly or indirectly prevents the completion of one or more steps in that pathway, thereby preventing or significantly reducing the production of one or more normal products or effects of that pathway. Thus, an agent specifically inhibits such a biochemical pathway requiring the expression product of a particular gene if the presence of the agent stops or substantially reduces the completion of the series of steps in that pathway. Such an agent may, but does not necessarily, act directly on the expression product of that particular gene.

“Integrated data” are data related to, or associated with, a unique identifier of a biological sample from which the data were obtained.

For the purpose of this invention, “metabolites” refers to the native small molecules (e.g. non-polymeric compounds) involved in metabolic reactions required for the maintenance, growth, and function of a cell. Enzymes, other proteins, and most peptides are generally not considered to be small molecules and are thus excluded from the definition of metabolite as used herein. Many proteins participate in biochemical reactions with small molecules (e.g. isoprenylation, glycosylation, and the like). The construction and degradation of polypeptides results in either the consumption or generation of small molecules, and thus, the small molecules rather than the proteins are metabolites.

Genetic material (all forms of DNA and RNA) is also excluded as a metabolite based on size and function. The construction and degradation of polynucleotides results in either the consumption or generation of small molecules, and thus, the small molecules rather than the polynucleotides are metabolites. Structural molecules (e.g. glycosaminoglycans and other polymeric units) similarly may be constructed of and/or degraded to small molecules, but do not otherwise participate in metabolic reactions. Thus, structural molecules are excluded from the definition of metabolite as used herein. Polymeric compounds, such as glycogen, are important participants in metabolic reactions as a source of metabolites, but are not chemically defineable (i.e. an input/output to metabolism). Thus, polymeric compounds are excluded from the definition of metabolite as used herein.

Metabolites of xenobiotics (chemical compounds foreign to the body or to living organisms) are neither native, required for maintenance or growth, nor required for normal function of a cell, and thus are not metabolites as used herein. However, it is useful to monitor xenobiotics when observing the effects of a drug therapy program, or in experimentally determining the effects of a compound on an individual. Essential or nutritionally required compounds are not synthesized de novo, (i.e. not native), but are required for the maintenance, growth, or normal function of a cell. Therefore, essential or nutritionally required compounds are metabolites as defined herein.

“Morphology” refers to the form and structure of an organism or any of its parts. Morphology is one way of referring to a phenotype.

“Peak” refers to the readout from any type of spectral analysis or metabolite analysis instrumentation, as is standard in the art, and can represent one or more chemical components. The instrumentation can include, but is not limited to, liquid chromatography (LC), high-pressure liquid chromatography (HPLC), mass spectrometry (MS), hyphenated detection systems such as MS-MS or MS-MS-MS, gas chromatography (GC), liquid chromatography/mass spectroscopy (LC-MS), gas chromatography/mass spectroscopy (GC-MS), Fourier transform-ion cyclotron resonance-mass spectrometry (FT-MS), nuclear magnetic resonance (NMR), magnetic resonance imaging (MRI), Fourier Transform InfraRed (FT-IR), and inductively coupled plasma mass spectrometry (ICP-MS). It is further understood that mass spectrometry techniques include, but are not limited to, the use of magnetic-sector and double focusing instruments, transmission quadrapole instruments, quadrupole ion-trap instruments, time-of-flight instruments (TOF), Fourier transform ion cyclotron resonance instruments (FT-MS), and matrix-assisted laser desorption/ionization time-of-flight mass spectrometry (MALDI-TOF MS). It is understood that the phrase “mass spectrometry” is used interchangeably with “mass spectroscopy” in this application.

“Phenotype” refers to the observable physical, morphological, and/or biochemical/metabolic characteristics of an organism, as determined by genetic and/or environmental factors. Histology is the anatomical study of the microscopic physical structure of animal and plant tissues. Thus, histological characteristics are an example of phenotypic data.

“Types of data,” as used herein, refer to data derived from different biological indicators. For example, types of data include, but are not limited to, data from DNA, data from RNA, data from proteins, data from metabolites, and data from phenotypic characteristics. Types of data are obtained by any process or technique known in the art; the process or technique used is immaterial to the creation of the coherence database. However, the process or technique from which the data emanates may affect how the data are integrated. “Disparate data” are comprised of different types of data.

Summary statistics are statistical methods applied to data with the intent of summarizing or describing raw unmanipulated data and are familiar to those skilled in the art. In one example, summary statistics can be used to obtain one number, such as an average or a correlation coefficient, to represent an entire data set. Summary data measurements, derived from summary statistics, are provided in a coherence database. Summary data measurements are related to the raw unmanipulated data from which the summary data originated. In one embodiment of the present invention, an experiment is performed in which three data types are collected. Data of a first type are summarized and placed in a first data table in a coherence database, data of a second type are summarized and placed in a second data table in the coherence database, and data of a third type are summarized and placed in a third data table in the coherence database. The summary data present in the three data tables are then further summarized or described so as to obtain summary data representative of all of the disparate data from the experiment. Summarization reduces large and complex data sets to a format that is more manageable and meaningful, and multiple summarizations of experimental data may be useful, as described above.

The present inventors have recognized that the massive amounts of biological data now available call for technological developments that support analyses of different types of data collectively and in a biologically relevant context. The invention presented herein is a support tool that enables other applications or software tools to be most successfully applied in data analysis, and the invention presented herein facilitates recognition and identification of trends and relationships within complex data.

Accordingly, the present invention provides methods and systems for recording and organizing summary data from experiments, relating data from disparate data streams, and relating data to reference information sources. The methods and systems of the present invention are useful in numerous applications, such as determining gene function; identifying and validating drug and pesticide targets; identifying and validating drug and pesticide candidate compounds; profiling of drug and pesticide compounds; predicting the toxicological impact of a drug or pesticide compound; producing a compilation of health or wellness profiles; identifying suites of compounds, proteins, genes, or combinations thereof to act as biomarkers of a biological status; determining compound sites of action; identifying unknown samples; and numerous other applications in the agricultural, pharmaceutical, nutraceutical, forensic, and biotechnology industries.

Thus, in one embodiment, the coherence database resulting from the methods and systems of the present invention is comprised of at least one data table containing a unique identifier of at least one experiment; at least one data table containing a unique identifier of at least one biological sample; at least one data table containing summary data measurements from the biological sample; at least one data table containing information about attributes pertaining to the summary data measurements; placing the data tables in an integrated relational database schema; and relating the data tables of the integrated relational database schema, through the attribute information, to at least one reference information source. The terms “data table” and “table” are used interchangably in the present application.

Experimental design and conditions include any factors that can be used to stratify data. The experimental design and conditions recorded may include, but are not limited to, organism species; organism type within a species (such as sex (male or female); age; race; body type (obese, thin, tall, short); behaviors such as smoking or exercising; presence or absence of disease; mutant type; or other factors contributing to a patient profile); sample type (tissue or fluids such as blood or urine); treatment type (drug or pesticide compound, mode of administration, length of time administered and amount administered); time point of sample harvest; or any clinical characteristic. Suitable sample parts of biological organisms include, but are not limited to, human and animal tissues such as heart muscle, liver, kidney, pancreas, spleen, lung, brain, intestine, stomach, skin, skeletal muscle, uterine muscle, ovary, testicle, prostate, and bone; human and animal fluids such as blood, plasma, serum, saliva, urine, mucus, semen, vaginal fluid, sweat, tears, amniotic fluid, and milk; freshly harvested cells such as hepatocytes or spleen cells; immortal cell lines such as the human hepatocyte cell line HepG2, the mouse fibroblast line L929, or other immortal cell lines known to those of skill in the art such as HepG2-C3A, THLE-3, 3T3-L1, MCL-5, H4IIE, HUVEC, L6, C2C12, 3T3-F442A, HIT-T15, C3H10T1/2, T84, and NCI-ADR-Res; human and animal cells grown in culture as three-dimensional culture spheres (e.g. liver spheroids); cultured fungi; and plant tissues such as cotyledons, leaves, seeds, open flowers, pistils, senescent flowers, sepals, siliques, and stamens.

The data measurements may include, but are not limited to, gene expression profiling, phenotypic analysis, metabolite analysis, proteomics, histological analysis, tissue feature analysis, 3-D protein structural analysis, and protein expression analysis. Other types of information useful in the methods of the invention include nucleotide sequence data, single nucleotide polymorphism (SNP) data, scientific literature, clinical chemistry data, and biochemical pathway data, all of which can provide tremendous insight into the workings of complex biological systems.

Gene expression profiling (GEP) refers to a simultaneous analysis of the expression levels of multiple genes. Traditionally, the expression of individual genes was analyzed by a technique called Northern-blot analysis. In a Northern-blot, RNA is separated on a gel, transferred to a membrane, and a specific gene is identified via hybridization to a radioactive complementary probe, usually made from DNA. A technological improvement in the area of GEP has been the development of small 1-2 cm chips used to concurrently determine expression levels of multiple genes from mulitple samples. In a gene chip format, probes for the genes of interest are ordered as an array on a glass slide. After hybridization to appropriate samples, gene expression changes are often visualized with colors overlaid on an image of the chip. The color indicates the gene expression level and the location indicates the specific gene being monitored. Other technologies can be used to obtain the same type of gene information, including high-density array spotting on glass or membranes and quantitative reverse transcription and PCR.

Phenotype refers to observable physical or biochemical/metabolic characteristics of an organism, as determined by genetic and environmental factors. For example, in an Arabidopsis thaliana plant model system, a phenotype can be described by using distinctly defined attributes such as, but not limited to, number of: abnormal seeds, cotyledons, normal seeds, open flowers, pistils per flower, senescent flowers, sepals per flower, siliques, and stamens. Perturbation of a biological system is often indicated by a phenotypic trait. In humans, a perturbed biological system may result in symptoms of disease such as chest pain, signs such as elevated blood pressure, or observable physical traits such as those exhibited by individuals afflicted with Trisomy 21. A normal phenotype is useful as a baseline value against which a physiological status can be measured.

Medical history, examination, and testing techniques are well known to medical practitioners and data derived from the same can be used in practicing the methods and systems of the present invention. For example, in cases where a practitioner is examining a patient to determine the likelihood, existence, or extent of coronary heart disease (CHD), phenotypic traits observed or identified in a clinical setting include, but are not limited to, risk factors such as blood pressure, cigarette smoking, total cholesterol (TC), low density lipoprotein cholesterol (LDL-C), high density lipoprotein cholesterol (HDL-C), and diabetes. P. G. McGovern et al., 334 NEW ENG. J. MED. 884-890 (1996). Additonal phenotypic characteristics such as body weight, family history of CHD, hormone replacement therapy, and left ventricular hypertrophy are also useful in determining CHD risk. It is common in the medical arts to scale or score a patient's condition based on a set of phenotypic signs and symptoms. For example, predictive models have been described based on blood pressure, cholesterol, and LDL-C categories as identified by the National Cholesterol Education Program and the Joint National Committee on Detection, Evaluation, and Treatment of High Blood Pressure. P. W. F. Wilson et al., 97 CIRCULATION 1837-1847 (1998) (incorporated herein by reference). Furthermore, predictive outcome models have also been described for patients undergoing coronary artery bypass grafting surgery and percutaneous transluminal coronary angioplasty.

Medical scoring of phenotypic traits is applicable to the assessment of patient well-being pre- and post-therapeutic intervention. For example, Short-Form 36 (SF-36) is gaining acceptance as a generic health outcome assessment form. SF-36 validates health outcomes with eight indices of health and well-being including general health (GH), physical function (PF), role function due to physical limitations (RP), role function due to emotional limitations (RE), social function (SF), mental health (MH), bodily pain (BP), and vitality and energy (VE). Each health object is scored on a 0 to 100 basis with higher scores representing better function or less pain. Other scoring or ranking schemas for identifying and quantifying physiologic and pathophysiologic (phenotypic) states (traits) include, not are not limited, the following: ATP III Metabolic Syndrome Criteria; Criteria for One Year Mortality Prognosis in Alcoholic Liver Disease; APACHE II Scoring System and Mortality Estimates (Acute Physiology and Chronic Health disease Classification System II); APACHE II Scoring System by Diagnosis; Apgar Score; Arrhythmogenic Right Ventricular Dysplasia Diagnostic Criteria; Arterial Blood Gas Interpretation; Autoimmune Hepatitis Diagnostic Criteria; Cardiac Risk Index in Noncardiac Surgery (L. Goldman et al., 297 NEW ENG. J. MED. 20 (1977)); Cardiac Risk Index in Noncardiac Surgery (A. S. Detsky et al., 1 J. GEN. INT. MED. 211-219 (1986)); Child Turcotte Pugh Grading of Liver Disease Severity; Chronic Fatigue Syndrome Diagnostic Criteria; Community Acquired Pneumonia Severity Scale; DVT Probability Score System; Ehlers-Danlos Syndrome IV (Vascular Type) Diagnostic Criteria; Epworth Sleepiness Scale (ESS); Framingham Coronary Risk Prediction (P. W. F. Wilson et al., 97 CIRCULATION 1837-1847 (1998)); Gail Model for 5 Year Risk of Breast Cancer (M. H. Gail et al., 91 J. NAT'L CANCER INST. 1829-1846 (1999); Geriatric Depression Scale; Glasgow Coma Scale; Gurd's Diagnostic Criteria for Fat Embolism Syndrome; Hepatitis Discriminant Function for Prednisolone Treatment in Severe Alcoholic Hepatitis; Irritable Bowel Syndrome Diagnostic Criteria (A. P. Manning et al., 2 BRIT. MED. J. 653-654 (1978)); Jones Criteria for Diagnosis of Rheumatic Fever; Kawasaki Disease Diagnostic Criteria; M.I. Criteria for Likelihood in Chest Pain with LBBB; Mini-Mental Status Examination; Multiple Myeloma Diagnostic Criteria; Myelodysplastic Syndrome International Prognostic Scoring System; Nonbiliary Cirrhosis Prognostic Criteria for One Year Survival; Obesity Management Guidelines (National Institutes of Health/NHLBI); Perioperative Cardiac Evaluation (NHLBI); Polycythemia Vera Diagnostic Criteria; Prostatism Symptom Score; Ranson Criteria for Acute Pancreatitis; Renal Artery Stenosis Prediction Rule; Rheumatoid Arthritis Criteria (American Rheumatism Association); Romhilt-Estes Criteria for Left Ventricular Hypertrophy; Smoking Cessation and Intervention (NHLBI); Sore Throat (Pharyngitis) Evaluation and Treatment Criteria; Suggested Management of Patients with Raised Lipid Levels (NHLBI); Systemic Lupus Erythematosis American Rheumatism Association 11 Criteria; Thyroid Disease Screening for Females More Than 50 Years Old (NHLBI); and Vector and Scalar Electrocardiography.

Still other phenotypic traits could be observed or identified by x-ray; cardiac and vascular angiography; electrocardiogaphy; blood pressure (BP) examination; pulse; weight and height; ideal body weight or BMI; retinal examination; thyroid examination; carotid bruits; neck vein examination; congestive heart failure (CHF) signs; palpable intercostal pulses; cardiovascular examination traits including, but not limited to, S4 gallop, tachycardia, bradycardia, heart sounds, aortic insufficiency, murmur, and echocardiography; abdominal examination; genitourinary examination; peripheral vascular disease examination; neurologic examination; and skin examination. In addition to standard x-ray technologies, numerous imaging technigues are also useful in observing and identifying phenotypic traits including, but not limited to, ultrasound, magnetic resonance imaging (MRI), positron emission tomography (PET), single photon emission computed tomography (SPECT), x-ray transmission, x-ray computed tomography (X-ray CT), ultrasound electrical impedance tomography (EIT), electrical source imaging (ESI), magnetic source imaging, (MSI) laser optical imaging.

Metabolite or biochemical analysis (also referred to as biochemical profiling or BCP) refers to an analysis of organic, inorganic, and/or bio-molecules (hereinafter collectively referred to as “small molecules”) of a cell, cell organelle, tissue and/or organism. It is understood that a small molecule is also referred to as a metabolite. Techniques and methods of the present invention employed to separate and identify small molecules, or metabolites, include but are not limited to: liquid chromatography (LC), high-pressure liquid chromatography (HPLC), mass spectroscopy (MS), gas chromatography (GC), liquid chromatography/mass spectroscopy (LC-MS), gas chromatography/mass spectroscopy (GC-MS), nuclear magnetic resonance (NMR), magnetic resonance imaging (MRI), Fourier Transform InfraRed (FT-IR), and inductively coupled plasma mass spectrometry (ICP-MS). It is further understood that mass spectrometry techniques include, but are not limited to, the use of magnetic-sector and double focusing instruments, transmission quadrapole instruments, quadrupole ion-trap instruments, time-of-flight instruments (TOF), Fourier transform ion cyclotron resonance instruments (FT-MS), and matrix-assisted laser desorption/ionization time-of-flight mass spectrometry (MALDI-TOF MS).

Metabolite or biochemical analysis allows relative amounts of metabolites to be determined in an effort to deduce a biochemical picture of physiology and/or pathophysiology. In one embodiment of the present invention, individual metabolites present in cells are identified and a relative response measured, establishing the presence, relative quantities, patterns, and/or modifications of the metabolites. In a related embodiment of the invention, the metabolites are related to enzymatic reactions and metabolic pathways. In another embodiment, rather than identifying metabolites, the spectral properties of chemical components in a biological sample are characterized and the presense or absence of the chemical components noted. In a further embodiment of the invention, a metabolic profile is obtained by analyzing a biological sample for metabolite composition under particular environmental conditions.

The methods and systems of the present invention are also useful in conjunction with data derived from histology studies. Histology is the anatomical study of the microscopic structure of animal and plant tissues. Histological analyses include recordation of traits directly observable and recordation of findings from image analysis. In one embodiment, the histological images are in an electronic format. In another embodiment, tissue feature analysis techniques are used in the acquisition of histological phenotypic data. Tissue feature analysis refers to quantitative tissue image analysis of structural features in tissue elements using digital microscopy to generate data that objectively describes tissue phenotype, with potential for detection of subtle changes that are undetectable to the human eye. One example of tissue feature analysis is described in Kriete et al., 4 Genome Biology R32.1-.9 (2003).

Attributes refer to any information useful in accessing or querying data, and may include, but are not limited to, information such as compound molecular weight, compound structure, gene sequence, gene annotation, gene splice variants, genes encoding particular proteins, protein molecular weight, protein isoelectric point, protein active domain sequence and/or consensus sequence, annotation and/or references pertaining to phenotypic or morphological data, tissue type, treatment type, and mutant type. Attributes are useful in relating empirical data to reference information sources.

Reference information sources include, but are not limited to, KEGG (Kyoto Encyclopedia of Genes and Genomes, Institute for Chemical Research, Kyoto University, Japan), BRENDA (The Comprehensive Enzyme Information System, Institute of Biochemistry, University of Cologne, Germany), Expert Protein Analysis System (ExPASy), or any other information source that provides a biological context for data analysis, including a proprietary data source. The biological context may include a biochemical pathways context, which may include substrates, products, and enzymes (all metabolites) and the genes that encode the metabolites. In another embodiment, a signal transduction context or a protein-binding (protein-protein interactions) context, such as cell surface binding, protein kinase reactions (signal transduction), cytokine binding (signal transduction), or antibody binding, is provided. In another embodiment, a cellular organelle context, such as a mitochondrial context, a cellular context, a tissue context, an organ context, an organ system context, or an entire organism context, is provided. In another embodiment, a chromosomal context, such as genes or metabolites represented on a chromosome map of a particular organism, is provided. In another embodiment, an image context is provided, such as a CAT (or CT) scan, an MRI, a histology image such as a section of an organ or tissue, a depiction of a human body, a depiction of a human tissue, organ, or organ system, a depiction of a leaf, a root, a stem, a flower, a seed, an entire plant, or any image of an organism or any part thereof. In yet another embodiment, a protein structure or model context is provided, such as the structure of an enzyme complex, on which genes are superimposed. In another embodiment, a context of global architecture of genetic interactions on protein networks is provided (O. Ozier et al., 21 NATURE BIOTECH., 490-491 (2003)). It is understood by those skilled in the art that any information source that is electronically recorded may be used in the methods and systems of the invention. Integration of a coherence database and a reference information source is enabled by querying for an attribute found both in the coherence database and in reference information sources.

To support the creation of a coherence database, proper technical infrastructure must be available. Appropriate computer hardware is supplied, for example, by the Sun Microsystems' E420 workgroup server (Sun Microsystems, Inc., Santa Clara, Calif.). Appropriate operating systems include, but are not limited to, Solaris (Sun Microsystems, Inc., Santa Clara, Calif.), Windows (Microsoft Corp., Redmond, Wash.), or Linux (Red Hat, Inc., Raleigh, N.C.). Appropriate software applications include, but are not limited to, relational databases such as Oracle 9.0.1 (9i) (Oracle Corp., Redwood Shores, Calif.), DB2 Universal Database V8.1 (IBM Corp., Armonk, N.Y.), or SQL Server 2000 (Microsoft Corp., Redmond, Wash.), and software for statistical analyses, such as packages available from SAS (SAS Institute, Inc., Cary, N.C.) or SPSS, Inc. (SPSS, Inc., Chicago, Ill.). In one embodiment, the server is the E420 workgroup server (Sun Microsystems, Inc., Santa Clara, Calif.), the operating system is Solaris (Sun Microsystems, Inc., Santa Clara, Calif.), and the software is Oracle 9.0.1 (9i) (Oracle Corp., Redwood Shores, Calif.), and statistical software is from SAS (SAS Institute, Inc., Cary, N.C.).

Thus, in one embodiment, the coherence database resulting from the methods and systems of the present invention is comprised of at least one data table containing a unique identifier of at least one experiment; at least one data table containing a unique identifier of at least one biological sample; at least two data tables containing summary data measurements from the biological sample; at least one data table containing information about attributes pertaining to the summary data measurements; placing the data tables in an integrated relational database schema; and relating the data tables of the integrated relational database schema, through the attribute information, to at least one reference information source. In one example, the at least two data tables containing summary data measurements from the biological sample are comprised of a first data type in a first data table and a second data type in a second data table. In a further example, the at least two data tables containing summary data measurements from the biological sample are comprised of a first data type in a first data table, a second data type in a second data table, and a third data type in a third data table.

In one embodiment of the present invention the data measurements include RNA data (gene expression profiling analysis), phenotypic data, and metabolite data (biochemical profiling analysis), but one skilled in the art will understand that data from any technology or process may be utilized in the methods and systems of the invention. Further, it is understood by one skilled in the art that data from any biological organism (alive or dead) or part thereof may be incorporated into a coherence database. Suitable biological organisms include, but are not limited to, plants, such as Arabidopsis (Arabidopsis thaliana), corn and rice, fungal organisms including Magnaporthe grisea, Saccharomyces cerevisiae, and Candida albicans, and mammals, including rodents, rabbits, canines, felines, bovines, equines, porcines, and human and non-human primates.

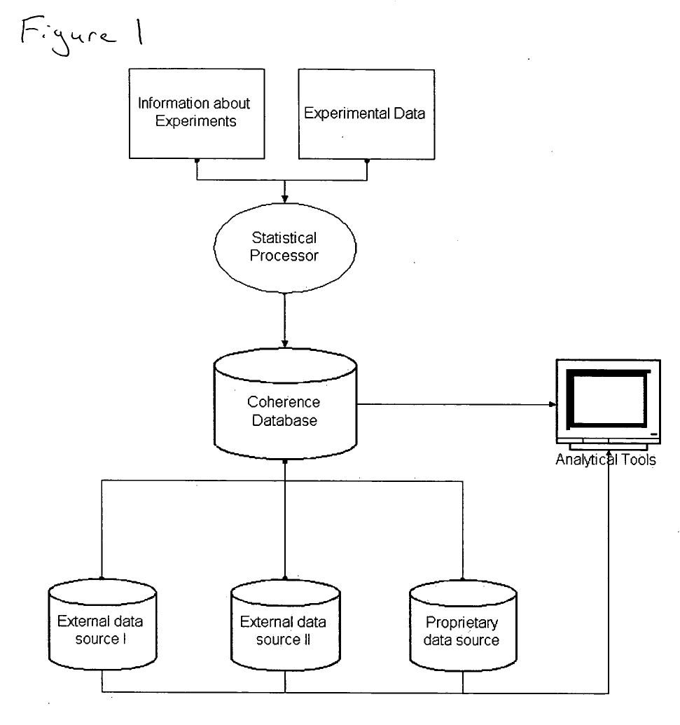

FIG. 1 depicts the flow of information in an exemplary coherence database schema. Information about experiments (101) represents detailed information pertaining to experimental design and conditions relating to the experimental design. In one instance, information about experiments (101) may be recorded in a laboratory information management system (LIMS). Each experiment is assigned a unique identifier. Unique experiment identifiers recorded in the coherence database (104) are related to detailed experimental information (101). Experiment information found in a coherence database includes a single unique identifier for an entire experiment, and attributes, which are specific references to particular features of the experiment. Experimental data (102) represents raw unmanipulated experimental data acquired directly from scientific instrumentation. The experimental data may be subject to processes such as quality control and quality assurance procedures. A statistical processor (103), in which the experimental data (102) is processed into summary data, is related to information about experiments (101). External data source I (105), external data source II (106), and proprietary data source (107) represent reference information sources external to the coherence database and separate from empirical information (experimental design (101) and experimental data (102)). Such separation of empirical data and reference data allows security measures to be implemented for protecting empirical data without hampering access to referenc information sources. External data source I (105) and external data source II (106) represent publicly available reference information sources, such as KEGG and BRENDA. Proprietary data source (107) represents any proprietary information source, such as information that is available from a segregated internal database or through a third party database provider, such as, for example, Incyte Corporation (Wilmington, Del.) or Genzyme Corporation (Cambridge, Mass.). The coherence database (104) is where all of the information depicted in FIG. 1 can be accessed and queried using the analytical tools (108). Contained within the coherence database (104) are data tables containing attributes, which are used to relate the information in the database to external data source I (105), external data source II (106), and proprietary data source (107). Note that external data source I (105), external data source II (106), and proprietary data source (107) represent reference information sources related to the coherence database (104).

It should be noted that while the coherence database (104) in FIG. 1 is depicted as one physical structure, a coherence database may be comprised of any number of data tables or databases if the information recorded is related. In one embodiment, the data to be utilized in the methods and systems of the current invention are recorded in data tables in a single database. In another embodiment, the data tables to be utilized in the methods and systems of the current invention are recorded in more than one separate database. In one example, GEP data are recorded in a first data table in a first database, BCP data are recorded in a second data table in a second database, and phenotypic data are recorded in a third data table in a third database. In this example, the GEP, BCP, and phenotypic data represent a coherence database because all of the data relate to a unique sample identifier and/or a unique experiment identifier.

In another example, GEP data are recorded in a first data table in a first database and BCP data are recorded in a second data table in a second database. In still another example, GEP data are recorded in a first data table in a first database and phenotypic data are recorded in a second data table in a second database. In yet another example, BCP data are recorded in a first data table in a first database and phenotypic data are recorded in a second data table in a second database. In a further example, GEP data are recorded in a first data table and BCP data are recorded in a second data table, both of which are recorded in a first database, and phenotypic data are recorded in a third data table in a second database. In another example, GEP data are recorded in a first data table and phenotypic data are recorded in a second data table, both of which are recorded in a first database, and BCP data are recorded in a third data table in a second database. In another example, BCP data are recorded in a first data table and phenotypic data are recorded in a second data table, both of which are recorded in a first database, and GEP data are recorded in a third data table in a second database.

In another embodiment, the coherence database resulting from the methods and systems of the present invention is comprised of at least one data table containing a unique identifier of at least one experiment; at least one data table containing a unique identifier of at least one biological sample; at least one data table containing summary data measurements from the biological sample, wherein the summary data measurements are from genes, proteins, metabolic compounds, or phenotype (including morphology or histology); at least one data table containing information about attributes pertaining to the summary data measurements; placing all of the data tables in an integrated relational database schema; and relating the data tables of the integrated relational database schema, through the attribute information, to at least one reference information source.

In a further embodiment, the coherence database resulting from the methods and systems of the present invention is comprised of at least one data table containing a unique identifier of at least one experiment; at least one data table containing a unique identifier of at least one biological sample; at least one data table containing summary data measurements from the biological sample; at least one data table containing information about attributes pertaining to the summary data measurements; placing the data tables in an integrated relational database schema; and relating the data tables of the integrated relational database schema, through the attribute information, to at least one reference information source, wherein the at least one reference information source is KEGG and/or BRENDA and/or ExPASy and/or any biochemical pathway or network information source.

In still another embodiment, the coherence database resulting from the methods and systems of the present invention is comprised of at least one data table containing a unique identifier of at least one experiment; at least one data table containing a unique identifier of at least one biological sample; at least one data table containing summary data measurements from the biological sample; at least one data table containing information about attributes pertaining to the summary data measurements, wherein the attributes may include compound molecular weight and/or structure, gene sequence, gene annotation, gene splice variants, genes corresponding to proteins, protein physical properties such as molecular weight and/or isoelectric point, tissue type, treatment type, mutant type, and/or phenotype/morphology annotation and references to publications; placing the data tables in an integrated relational database schema; and relating the data tables of the integrated relational database schema, through the attribute information, to at least one reference information source.

In yet another embodiment, the coherence database resulting from the methods and systems of the present invention is comprised of at least one data table containing a unique identifier of at least one experiment; at least one data table containing a unique identifier of at least one biological sample; at least one data table containing summary data measurements from the biological sample, wherein the summary data measurements are from genes, proteins, metabolic compounds, or phenotype (including morphology or histology); at least one data table containing information about attributes pertaining to the summary data measurements; placing the data tables in an integrated relational database schema; and relating the data tables of the integrated relational database schema, through the attribute information, to at least one reference information source, wherein the reference information source is KEGG and/or BRENDA and/or ExPASy and/or any biochemical pathway or network information source.

In a further embodiment, the coherence database resulting from the methods and systems of the present invention is comprised of at least one data table containing a unique identifier of at least one experiment; at least one data table containing a unique identifier of at least one biological sample; at least one data table containing summary data measurements from the biological sample, wherein the summary data measurements are from genes, proteins, metabolic compounds, or phenotype (including morphology or histology); at least one data table containing information about attributes pertaining to the summary data measurements, wherein the attributes may include compound molecular weight and/or structure, gene sequence, gene annotation, gene splice variants, genes corresponding to proteins, protein physical properties such as molecular weight and/or isoelectric point, tissue type, treatment type, mutant type, and/or phenotype/morphology annotation and references to publications; placing the data tables in an integrated relational database schema; and relating the data tables of the integrated relational database schema, through the attribute information, to at least one reference information source, wherein the reference information source is KEGG and/or BRENDA and/or ExPASy and/or any biochemical pathway or network information source. It is understood by those of ordinary skill in the art that not all possible examples of integrated relational database schema are listed here and, accordingly, additional ways of creating a coherence database fall under the scope of the present invention.

### Experimental

### EXAMPLE 1

### Tables of Experimental Design and Conditions

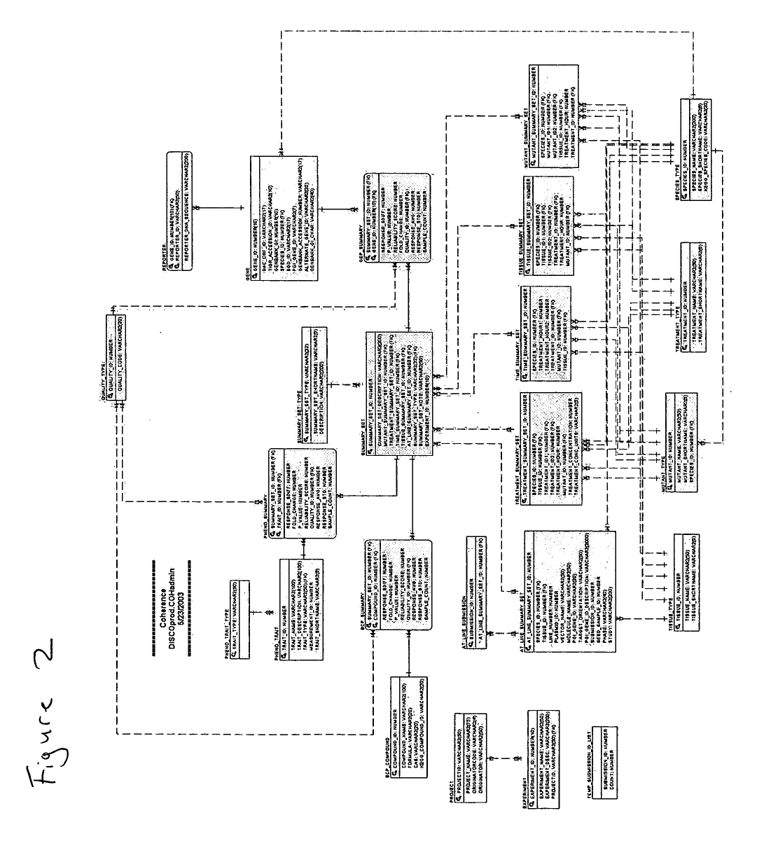

FIG. 2 portrays a detailed coherence database schema, with the contents of each data table specified. In the current example, experimental design and conditions using Arabidopsis thaliana plants were determined and the data tables were populated accordingly. Referring to FIG. 2, table 221 represents a data table containing details about sample (tissue) type, table 222 represents a data table containing details about organism mutant type (for example, a transgenic organism), table 223 represents a data table containing details about the experimental treatment type, and table 224 represents a data table containing details about the organism species type. These four data tables are related in various ways to summary data tables populated with information of various types regarding the experiments. Referring still to FIG. 2, the tissue type (221) and species type (224) are related to the AT Line summary set data table (216). The “AT Line” refers to the Arabidopsis thaliana plant line and contains details of the specifics of the plant line, including genetic information. Table 215 is a look-up data table providing a workflow tracking mechanism for the large number of plants processed and is related to AT Line summary set data table (216). Tissue type (221), species type (224), mutant type (222) and treatment type (223) are also related to the treatment summary set data table (217), the time summary set data table (218), the tissue summary set data table (219), and the mutant summary set data table (220). This structure provides access to all of the experimental details by enabling queries using any of the information populating the data tables.

Tables 212 and 213, as depicted in FIG. 2, are “bookkeeping” data tables, which allow tracking of projects. Table 205 is a QC data table, permitting quality control of the data in the summary sets. Table 212 is related to table 213 in a one-to-many relationship, wherein table 212 contains a project identifier, and table 213 contains the identifiers for the experiments associated with that project. Table 213 is related to the primary summary set data table (209). Table 205 allows quality control of the data in the summary sets of each type of data, and therefore is related to the phenotypic summary set (203), the gene expression profiling summary set (208), and the biochemical profiling summary set (211).

### EXAMPLE 2

### Tables of Data Measurements

As illustrated in FIG. 2, data measurements were obtained from Arabidopsis thaliana plants using the various experimental conditions identifed in the data tables discussed in Example 1 above. Tables 203, 208, and 211 are summary set data tables for each type of data obtained in this experiment. Table 203 contains phenotypic data. Table 208 contains gene expression profiling, or GEP, data. Table 211 contains biochemical profiling, or BCP, data.

### EXAMPLE 3

### Tables of Attributes and Relationships to External Information Sources

FIG. 2 depicts data tables containing specific attributes pertaining to different data types within the coherence database. Referring to FIG. 2, table 202 contains attributes pertaining to phenotype, such as leaf color, leaf size, and root length, and is related to the phenotype data summary set data table (203). Table 201 is a look-up data table providing information about the different phenotypic traits being studied, and is related to table 202. Table 207 contains attributes pertaining to genes, such as gene accession numbers in the various public databases, including the TIGR (The Institute for Genomic Research) and GenBank databases. Table 207 is related to the gene data summary set data table (208). Table 206 is a look-up data table providing information (including nucleotide sequence information) directed to different genes or gene fragments used in the gene expression profiling studies, and is related to table 207. Table 210 contains attributes pertaining to biochemical compounds or metabolites, such as compound name, chemical formula, CAS number, and KEGG compound identifier. Table 210 is related to the biochemical profiling summary data set data table (211). Attributes are useful in accessing or querying data in the coherence database, and are used to relate data in the coherence database to external information sources.

### EXAMPLE 4

### Primary Summary Set Table

As is shown in FIG. 2, a central data table called the summary set data table (209) was related to a look-up data table containing descriptions of the summary set types (204). Table 204 contains summary set types such as mutant type, treatment type, time, tissue type, and Arabidopsis line. The primary summary set data table (209) contains information from throughout the coherence database, allowing queries of any of the data contained therein.

### EXAMPLE 5

### Acetaminophen Activity in Rat Tissue

Acetaminophen overdose is one of the leading causes of liver failure. In this experiment, rats were dosed with acetaminophen and livers were harvested across a time course. Two doses of acetaminophen were used (50 mg/kg and 1500 mg/kg), as well as a control group that received no acetaminophen. The harvest times were 6, 18, 24, and 48 hours. Three rats (biological replicates) were in each treatment group, wherein a treatment group is defined as each combination of dose and time. Referring now to FIG. 2, experimental information was entered into data tables 221, 223, and 224 (tissue_type=liver, treatment_type=acetaminophen, treatment_concentration=dose, and species_type=rat) in the coherence database and is also summarized in table 217 (treatment_summary_set), thus allowing comparison of two or more treatment types. Still referring to FIG. 2, the information recorded in data tables 221, 223, and 224 could also be recorded in data tables 218 and 219 (time_summary_set, and tissue_summary_set), thus allowing comparison by time or tissue type.

The resulting liver samples were extracted and analyzed by biochemical profiling (BCP) using LC/MS in both positive and negative modes, yielding a biochemical profile containing intensities on more than 100 compounds. Three technical replicates of each rat liver were analyzed.

The following statistical manipulations were accomplished in the statistical processor (103), as illustrated in FIG. 1. The first step in the analysis was to log-transform the data to stabilize the variances and approximate normality. The next step was to calculate an average response for each treatment group and a standard deviation that measures the biological variation in the treatment group for each compound.

After calculating means and standard deviations, the next step was to calculate each treatment group's average deviation from its matched control group (i.e. the group with the same time point and treatment concentration=0) for each compound. This average deviation was divided by the standard error of the difference to obtain a standardized distance from control for each compound.

A summary set was created for each treatment group, and the experimental information associated with that treatment group (treatment, dosage, timepoint, baseline of comparison) was recorded in the coherence database. This is illustrated as the information flow represented in FIG. 1 from the statistical processor (103) to the coherence database (104). Comparing a treated group to a control group created summaries that were recorded in the treatment_summary_set data table (FIG. 2, table 217) of the coherence database schema. The identity of each summary set and the corresponding summary_set_description were recorded in the summary_set data table (FIG. 2, table 209).

Next, the standardized distance for each compound in each summary set was recorded in the bcp summary data table (FIG. 2, table 211), along with the corresponding p-value. Each compound in the data table was related to a KEGG identifier (FIG. 2, table 210), so that an informaticist could obtain from KEGG a list of pathway(s) in which the compound appears.

At this point, scientists queried the database and discovered that more compounds were perturbed at the 18 hour timepoint than any other. Consequently, a pathway query tool was used to obtain a list of pathways showing metabolic perturbation at the 18 hour timepoint. Using a pathway viewing tool on the 18 hour timepoint data led to the conclusion that the nitrogen metabolism pathway was most likely the source of the primary metabolic disturbance. This exemplifies how the coherence database of the present invention facilitated data analysis by enabling queries using aspects of the experimental design and by using attributes to relate to a data source (KEGG) external to the coherence database.

### EXAMPLE 6

### Herbicide Mode of Action Experiment

Eighteen known herbicides were used to treat Arabidopsis plants. The first experiment was a dose-response experiment, used to determine the Minimum Inhibitory Concentration (MIC) and Time to reach complete inhibition (TMIC) for each herbicide. Following this preliminary work, an experiment was performed in which Arabidopsis plants were treated with the 18 herbicides. For each herbicide, the MIC was used, and plants were harvested at 30%, 50% and 70% of TMIC timepoints. Because the timepoints were different for herbicides that act at different rates, matched control plants were harvested at the same timepoints. Before harvesting, each plant was rated on 12 phenotypic measurements determined to be relevant to herbicide action. From the leaf tissue samples, biochemical profiling (as in Example 5), and gene expresssion profiling (GEP) were carried out.

The standardized differences from matched controls were calculated as described in Example 5, using the biochemical profiling data, gene expression profiling data, and the phenotypic data. Referring now to FIG. 2, a summary set was created for each herbicide at each timepoint, the herbicide (treatment) name and timepoint for each summary set were recorded in the treatment_summary_set data table (217), and the summary set description was recorded in the summary_set data table (209). The standardized differences from matched controls were recorded in the bcp_summary (211), gep_summary (208), and pheno_summary data tables (203). The compounds in the bcp_summary data table and the genes in the gep_summary data table were related to KEGG identifiers through the BCP attribute data table (210) and the GEP attribute data table (207).

Cluster analysis was performed on the biochemical profiling and gene expression profiling data separately, to determine that the early timepoint (30% TMIC) was optimal for observing gene expression changes, while the late timepoint (70% TMIC) was optimal for detecting biochemical changes.

The early-timepoint gene expression data and the late-timepoint biochemical profiling data were combined with the phenotypic data and used to develop a discriminant function that was able to classify herbicides into functional classes with 100% accuracy.

Herbicides with unknown modes of action could be further examined by using a pathway viewing tool to explore the biochemical and gene expression data. This would lead to testable hypotheses about the unknown mode(s) of action.

### EXAMPLE 7

### Fungicide Mode of Action Study

An experiment was performed to attempt to characterize four fungicidal drugs: Amphoteracin B, Ketaconazole, Fluconazole, and Posaconazole. Yeast samples (Saccharomyces cerevisiae) were treated with an inhibitory dose of each drug, using three replicate samples per drug, and harvested at a single timepoint. Biochemical profiling and gene expression profiling data were gathered on each yeast sample, and summarized and related to KEGG as described in Example 6.

A pathway analysis tool was used to discover which pathways showed the most perturbation for each treatment, and to compare the treatments to each other. The conclusion was made that Posaconazole (not yet commercially available) behaved most like Fluconazole and both showed perturbations that were unlike those of Amphoteracin B.

The pathway analysis tool also showed that, although the drug target pathway was perturbed, many other pathways were equally or more perturbed, suggesting that an earlier harvest timepoint would facilitate the discovery of primary sites of action.

Published references and patent publications cited herein are incorporated by reference as if terms incorporating the same were provided upon each occurrence of the individual reference or patent document. While the foregoing describes certain embodiments of the invention, it will be understood by those skilled in the art that variations and modifications may be made that will fall within the scope of the invention. The foregoing examples are intended to exemplify various specific embodiments of the invention and do not limit its scope in any manner.

1. A method for creating a database, comprising:
a) creating at least one data table containing a unique identifier of at least one experiment;
b) creating at least one data table containing a unique identifier of at least one biological sample obtained from the experiment of step (a);
c) creating at least one data table containing summary data measurements from said at least one biological sample;
d) creating at least one data table containing information about attributes pertaining to the summary data measurements of step (c);
e) placing the data tables from steps (a) through (d) in an integrated relational database schema; and
f) relating the data tables in the integrated relational database schema to at least one reference information source, wherein the attributes of step (d) provide the relationship between the integrated relational database schema data and the at least one reference information source.

2. The method of claim 1, wherein the summary data measurements are comprised of gene expression profiling data measurements.

3. The method of claim 1, wherein the summary data measurements are comprised of biochemical profiling data measurements.

4. The method of claim 1, wherein the summary data measurements are comprised of gene expression profiling data measurements and biochemical profiling data measurements.

5. The method of claim 1, wherein the summary data measurements are comprised of phenotypic data measurements.

6. The method of claim 1, wherein the summary data measurements are comprised of phenotypic data measurements and gene expression profiling data measurements.

7. The method of claim 1, wherein the summary data measurements are comprised of phenotypic data measurements and biochemical profiling data measurements.

8. The method of claim 1, wherein the summary data measurements are comprised of gene expression profiling data measurements, phenotypic data measurements, and biochemical profiling data measurements.

9. The method of claim 1, wherein the at least one reference information source is selected from the group consisting of KEGG, ExPASy or Brenda.

10. A method for creating a database, comprising:
a) creating at least one data table containing a unique identifier of at least one experiment;
b) creating at least one data table containing a unique identifier for at least one biological sample obtained from the experiment of step (a);
c) creating at least two data tables containing summary data measurements from said at least one biological sample;
d) creating at least one data table containing information about attributes pertaining to the summary data measurements of step (c);
e) placing the data tables in steps (a) through (d) in an integrated relational database schema; and
f) relating the data tables in the integrated relational database schema to at least one reference information source, wherein the attributes of step (d) provide the relationship between the integrated relational database schema data and the at least one reference information source.

11. The method of claim 10, wherein the summary data measurements of step (c) are comprised of a first data type in a first data table and a second data type in a second data table.

12. The method of claim 10, wherein the summary data measurements of step (c) are comprised of a first data type in a first data table, a second data type in a second data table, and a third data type in a third data table.

13. The method of claim 10, wherein the summary data measurements are comprised of gene expression profiling data measurements and biochemical profiling data measurements.

14. The method of claim 10, wherein the summary data measurements are comprised of phenotypic data measurements and gene expression profiling data measurements.

15. The method of claim 10, wherein the summary data measurements are comprised of phenotypic data measurements and biochemical profiling data measurements.

16. The method of claim 10, wherein the summary data measurements are comprised of gene expression profiling data measurements, phenotypic data measurements, and biochemical profiling data measurements.

17. The method of claim 10, wherein the at least one reference information source is selected from the group consisting of KEGG, ExPASy or Brenda.

18. A system for creating a database, comprising:
a) means for creating at least one data table containing a unique identifier of at least one experiment;
b) means for creating at least one data table containing a unique identifier for at least one biological sample obtained under the experiment of step (a);
c) means for creating at least one data table containing summary data measurements from said at least one biological sample;
d) means for creating at least one data table containing information about attributes pertaining to the summary data measurements of step (c);
e) means for placing the data tables in steps (a) through (d) in an integrated relational database schema; and
f) means for relating the data tables in the integrated relational database schema to at least one reference information source, wherein the attributes of step (d) provide the relationship between the integrated relational database schema data and the at least one reference information source.

19. The system of claim 18, wherein the summary data measurements are comprised of gene expression profiling data measurements.

20. The system of claim 18, wherein the summary data measurements are comprised of biochemical profiling data measurements.

21. The system of claim 18, wherein the summary data measurements are comprised of gene expression profiling data measurements and biochemical profiling data measurements.

22. The system of claim 18, wherein the summary data measurements are comprised of phenotypic data measurements.

23. The system of claim 18, wherein the summary data measurements are comprised of phenotypic data measurements and gene expression profiling data measurements.

24. The system of claim 18, wherein the summary data measurements are comprised of phenotypic data measurements and biochemical profiling data measurements.

25. The system of claim 18, wherein the summary data measurements are comprised of gene expression profiling data measurements, phenotypic data measurements, and biochemical profiling data measurements.

26. The system of claim 18, wherein the at least one reference information source is selected from the group consisting of KEGG, ExPASy or Brenda.

27. A system for creating a database, comprising:
a) means for creating at least one data table containing a unique identifier of at least one experiment;
b) means for creating at least one data table containing a unique identifier for at least one biological sample obtained under the experiment of step (a);
c) means for creating at least two data tables containing summary data measurements from said at least one biological sample;
d) means for creating at least one data table containing information about attributes pertaining to the summary data measurements of step (c);
e) means for placing the data tables in steps (a) through (d) in an integrated relational database schema; and
f) means for relating the data tables in the integrated relational database schema to at least one reference information source, wherein the attributes of step (d) provide the relationship between the integrated relational database schema data and the at least one reference information source.

28. The system of claim 27, wherein the summary data measurements of step (c) are comprised of a first data type in a first data table and a second data type in a second data table.

29. The system of claim 27, wherein the summary data measurements of step (c) are comprised of a first data type in a first data table, a second data type in a second data table, and a third data type in a third data table.

30. The system of claim 27, wherein the summary data measurements are comprised of gene expression profiling data measurements and biochemical profiling data measurements.

31. The system of claim 27, wherein the summary data measurements are comprised of phenotypic data measurements and gene expression profiling data measurements.

32. The system of claim 27, wherein the summary data measurements are comprised of phenotypic data measurements and biochemical profiling data measurements.

33. The system of claim 27, wherein the summary data measurements are comprised of gene expression profiling data measurements, phenotypic data measurements, and biochemical profiling data measurements.

34. The system of claim 27, wherein the at least one reference information source is selected from the group consisting of KEGG, ExPASy or Brenda.
